(19) United States
(12) Patent Application Publication
(10) Pub. No.: US 2026/0099492 A1
(43) Pub. Date: Apr. 9, 2026

(54) AI Usage And Response

(71) Applicant: Richard Wilson, Southbury, CT (US)

(72) Inventor: Richard Wilson, Southbury, CT (US)

(21) Appl. No.: 19/353,019

(22) Filed: Oct. 8, 2025

Related U.S. Application Data
(60) Provisional application No. 63/705,479, filed on Oct. 9, 2024.

(51) Int. Cl. G06F 16/2452; G06F 16/2457

(52) U.S. Cl. CPC G06F 16/24528; G06F 16/24578

(57) ABSTRACT

A computer-implemented method for improving response generation includes receiving an input from a user, converting the input into a format, and comparing the format against known entries of an existing knowledge-base. Each known entry is related to a response. If the format matches one of the known entries, then the method further includes sending the response to the user. If the format does not match any of the known entries, then the method further includes sending the input to an AI system and receiving a valid response from the AI system.

### CROSS-REFERENCE TO RELATED APPLICATIONS

This application claims the benefit of U.S. Provisional Patent Application 63/705,479, filed Oct. 9, 2024, entitled Improvement For AI Usage And Response, which is hereby incorporated by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to artificial intelligence systems. By definition, generative AI solutions generate a response to an input. This creates a number of undesirable results, including: inconsistency of response to the same or similar inputs; responses that contain factual inaccuracies that are presented in a way that is often interpreted by users an authoritatively correct (often called hallucinations); and, repetitive processing of same, or similar, inputs that result in slower response and increased energy consumption than non-generative offerings.

The present invention seeks to provide users with the benefits of solutions like generative AI while curtailing inherent issues related to inconsistencies, inability to address hallucinations, response time, and undesirable environmental impact compared to other offerings.

### BRIEF SUMMARY OF THE INVENTION

In an embodiment of the present invention, a computer-implemented method for improving response generation comprises receiving an input from a user, converting the input into a format, and comparing the format against a plurality of known entries of an existing knowledge-base. Each of the plurality of known entries is related to a response. If the format matches one of the plurality of known entries, then the method further comprises sending the response to the user. If the format does not match any of the plurality of known entries, then the method further comprises sending the input to an AI system and receiving a valid response from the AI system.

In another embodiment of the present invention, the computer-implemented method for improving response generation further comprises indicating the valid response is from the AI system.

In yet another embodiment of the present invention, the computer-implemented method for improving response generation further comprises incorporating the format and the valid response into the existing knowledge-base.

In another embodiment of the present invention, the AI system is a generative AI system.

In yet another embodiment of the present invention, the computer-implemented method for improving response generation further comprises comparing the valid response to authoritative sources and scoring the valid response, based upon the comparison to the authoritative sources, as high, medium or low.

In another embodiment of the present invention, if the valid response is scored as high, then the method further comprises incorporating the format and the valid response into the existing knowledge-base and sending the valid response to the user. If the valid response is scored as low, then the method further comprises discarding the valid response.

In yet another embodiment of the present invention, if the valid response is scored as medium, then the method further comprises quarantining the valid response. The method may further comprise sending the user a message indicating that the valid response is quarantined. The method may also further comprise receiving edits to the valid response from an authorized editor. The method may also comprise incorporating the format and the valid response into the existing knowledge-base and sending the valid response with the edits to the user.

### BRIEF DESCRIPTION OF THE SEVERAL VIEWS OF THE DRAWING

FIG. 1 shows an embodiment of the present invention.

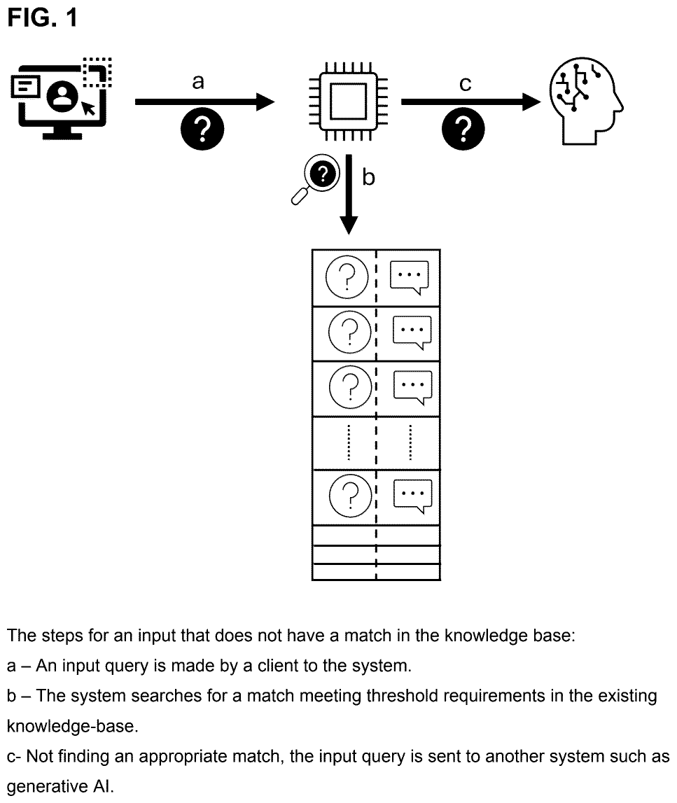

FIG. 2 shows an embodiment of the present invention.

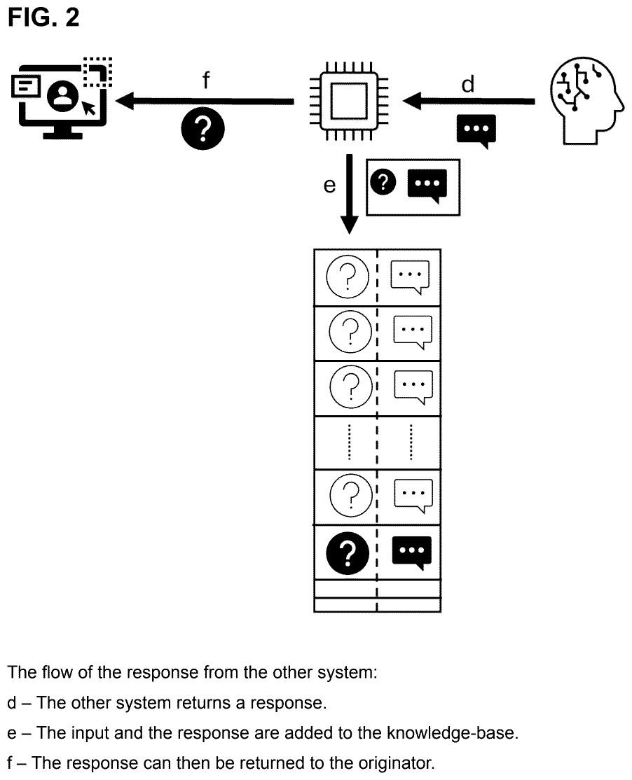

FIG. 3 shows an embodiment of the present invention.

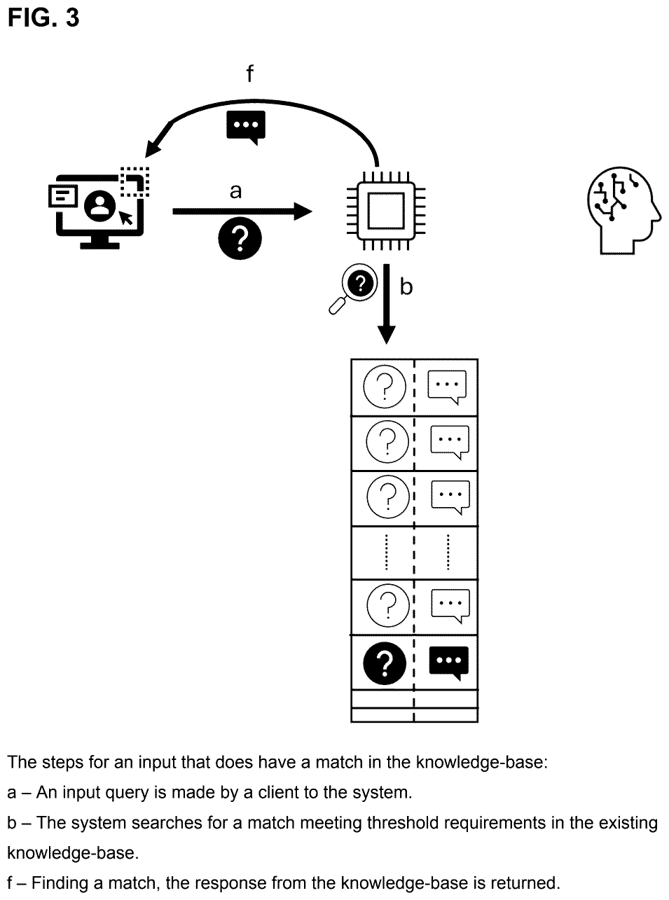

For clarity purposes, all reference numerals may not be included in every figure.

### DETAILED DESCRIPTION OF THE INVENTION

Existing generative based systems have a number of undesirable characteristics, including inconsistency of response to the same or similar inputs; responses that contain factual inaccuracies that are presented in a way that is often interpreted by users an authoritatively correct (often called hallucinations); and, repetitive processing of same, or similar, inputs that result in slower response and increased energy consumption than non-generative offerings.

Unlike the existing offerings of purely generative response, the present invention provides users with consistent response to the same, or similar, queries and allows for the updating and correction of the response. This also has the benefits of speeding up the response and decreasing the environmental impact by reducing required processing.

The present invention allows the leveraging of a known knowledge-base of information with defined responses that allows for inputs that do not meet the matching threshold to be sent to another system, like a generative AI solution. Any response received from the other system can then be incorporated into the known knowledge-base of information. The users of the system that incorporate this present invention gain a number of benefits, including: receiving a consistent response for the same or similar input whether that input was in the known knowledge-base prior to the first time the input was issued; reduced processing time and energy consumption compared to a purely generative based solution; and, an ability to edit the known knowledge-base to instantiate desired information and thus avoid factually incorrect responses (hallucinations).

A solution that allows users the ability to have a knowledge-base of known inputs and associated responses has a number of benefits. Incorporating a mechanism to leverage generative technology for inputs that do not meet the matching criteria for the known knowledge-base but then incorporating the results from the generative technology has a number of additional benefits beyond those resulting from either of the two types of solutions being used independently. The novel feedback mechanism for incorporating the generative response into the known knowledge-base results in a more favorable solution.

The present invention is a computer-implemented method for improving the generation of a response. As illustrated in the figures, the computer system receives a user input, which may be a query or request. Then, the user input is converted into a format (through Natural Language Processing) that is compared against known entries of an existing knowledge-base. Each known entry is related to a response. The response is returned to the user if the format matches one of the known entries. If the format does not match any of the plurality of known entries, then the user input is sent to a generative AI system, which generates a valid response. Then the user receives the valid response.

The computer-implemented method may also indicate that the valid response is from the generative AI system. The computer-implemented method may also incorporate the format and the valid response into the existing knowledge-base.

The computer-implemented method may also compare the valid response to authoritative sources, such as internal documentation of the user's organization. Then, the valid response may be scored or ranked based upon the comparison of the valid response to the authoritative sources. The score may be numerical or other mechanism, for example, “high,” “medium” and “low.” If the valid response is scored to be within the client's definition of “high”, then the format and the valid response are incorporated into the existing knowledge-base. Then, the valid response is sent to the user.

If the valid response is ranked as low, then the valid response may be discarded and will not be incorporated into the existing knowledge-base.

If the valid response is scored as medium, then the valid response may be quarantined. An authorized editor (for example, someone within the organization that has the authority to review the valid response) may edit the quarantined valid response. Then the format and the edited valid response are incorporated into the existing knowledge-base. Then, the edited valid response is sent to the user. The edits may be made by the original user or another user. The present invention increases efficiency because any future inquiries that are the same or similar to the original user input allows the computer system to provide a rapid, valid and consistent response. The authorized editor may optionally decide that the quarantined valid response is not incorporated into the existing knowledge-base and not sent to the user.

The scoring may also utilize a numeric scoring system where the organization designates ranges for different actions and outcomes, for example, a score of 95+ is treated as “high” in the above examples, 94-83.5 are treated as “medium” and thus require review, and scores below 83.5 are treated as “low.”

As an illustrative example, an end user might query the system with the following input “How do I change my 401k?” The system would take this input and first try to match that input query against its existing knowledge-base of queries and responses.

Assuming there is not a match in the existing knowledge-base that meets the set threshold matching criteria, the query would be forwarded to a designated “other solution” that may or may not be a generative AI instance, likely fine-tuned using the client organizations internal documents. The other solution would respond with what may be a generative answer, in this example “Changes to an employee's 401k can be made through the third-party retirement website.”

Other solutions may include, but are not limited to, AI systems, such as generative AI, predictive AI, analytical AI, rule-based AI and agentic AI.

Depending upon the client's configuration and their requirement to score or review non verified information, this response may be forwarded to the initial requestor. Additionally, the initial input query and the automated response may be ingested into the knowledge-base. This ingestion may be automated or may require review and authorization by someone in the organization depending upon the client's configuration and their requirement to score or review non verified information.

After ingestion into the knowledge-base, the next input query matching “How do I change my 401k?” would receive the response “Changes to an employee's 401k can be made through the third-party retirement website.”

Upon review, an authorized member of the organization may update the entry in the knowledge-base to “Changes to an employee's 401k can be made through the third-party retirement website.” by updating “third-party retirement website.” to be a URL Link. Then the next input query matching “How do I change my 401k?” would receive the response that includes the URL link.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention is not limited to the particular embodiments disclosed as the best mode contemplated for carrying out this invention, but that the invention will include all embodiments falling within the scope of the appended claims. Moreover, unless specifically stated any use of the terms high, medium, low, etc. do not denote any order or importance, but rather the terms high, medium, low, etc. are used to distinguish one element from another

I claim:

1. A computer-implemented method for improving response generation, comprising:
receiving an input from a user;
converting the input into a format; and,
comparing the format against a plurality of known entries of an existing knowledge-base, wherein each of the plurality of known entries is related to a response;
wherein if the format matches one of the plurality of known entries, then the method further comprises sending the response to the user; and,
wherein if the format does not match any of the plurality of known entries, then the method further comprises:
sending the input to an AI system; and,
receiving a valid response from the AI system.

2. The computer-implemented method for improving response generation of claim 1, further comprising:
indicating the valid response is from the AI system.

3. The computer-implemented method for improving response generation of claim 1, further comprising:
incorporating the format and the valid response into the existing knowledge-base.

4. The computer-implemented method for improving response generation of claim 1, wherein the AI system is a generative AI system.

5. The computer-implemented method for improving response generation of claim 1, further comprising:
comparing the valid response to authoritative sources; and,
scoring the valid response, based upon the comparison to the authoritative sources, as high, medium or low.

6. The computer-implemented method for improving response generation of claim 5, wherein if the valid response is scored as high, then the method further comprises:
incorporating the format and the valid response into the existing knowledge-base; and,
sending the valid response to the user.

7. The computer-implemented method for improving response generation of claim 6, wherein the AI system is a generative AI system.

8. The computer-implemented method for improving response generation of claim 5, wherein if the valid response is scored as low, then the method further comprises discarding the valid response.

9. The computer-implemented method for improving response generation of claim 8, wherein the AI system is a generative AI system.

10. The computer-implemented method for improving response generation of claim 5, wherein if the valid response is scored as medium, then the method further comprises quarantining the valid response.

11. The computer-implemented method for improving response generation of claim 10 further comprises sending the user a message indicating that the valid response is quarantined.

12. The computer-implemented method for improving response generation of claim 11 further comprising receiving edits to the valid response from an authorized editor.

13. The computer-implemented method for improving response generation of claim 12 further comprises:
incorporating the format and the valid response into the existing knowledge-base; and,
sending the valid response with the edits to the user.

14. The computer-implemented method for improving response generation of claim 13, wherein the AI system is a generative AI system.
